(19) United States
(12) Patent Application Publication
(10) Pub. No.: US 2012/0091788 A1
(43) Pub. Date: Apr. 19, 2012

(54) BRAKE SYSTEM FOR A VEHICLE AND METHOD FOR OPERATING A BRAKE SYSTEM FOR A VEHICLE

(76) Inventors: Reinhard WEIBERLE, Vaihingen/Enz (DE); Timo Jahnz, Besigheim (DE)

(21) Appl. No.: 13/267,687

(22) Filed: Oct. 6, 2011

(30) Foreign Application Priority Data
Oct. 13, 2010 (DE) 10 2010 042 363.7

(51) Int. Cl. B60T 13/66; B60T 8/17; B60T 7/00

(52) U.S. Cl. 303/15; 60/568; 60/545

(57) ABSTRACT

A brake system for a vehicle includes: a brake activation element; an input piston displaceable by at least a predefined minimum actuator travel distance when the brake activation element is operated; an output piston to which a driver braking force is transmittable from the brake activation element via the displaced input piston such that an internal pressure in a piston-cylinder unit of the brake system is increased; a first brake booster; and a spring device which, when the brake activation element is operated for an actuator travel distance which is less than the minimum actuator travel distance, is deformed in such a way that transmission of the driver braking force to the output piston is prevented.

### BACKGROUND OF THE INVENTION

1. Field of the Invention

The present invention relates to a brake system for a vehicle and a method for operating a brake system for a vehicle.

2. Description of the Related Art

Electric vehicles and hybrid vehicles have a brake system which is designed for regenerative braking, having an electric motor which is operated as a generator during the regenerative braking. The electrical energy obtained during the regenerative braking, after being temporarily stored, is preferably used for accelerating the vehicle. Power loss which a conventional vehicle experiences due to frequent braking during traveling, energy consumption, and exhaust gas emissions of the electric or hybrid vehicle may be reduced in this way.

However, operating the electric motor, the electric drive motor, for example, as a generator generally requires a certain minimum speed of the vehicle. Thus, a regenerative brake system is often not able to exert a generator mode braking torque on the wheels of the vehicle until the vehicle, which was previously traveling, comes to a stop. For this reason, in addition to the regeneratively operated electric motor a hybrid vehicle also frequently has a hydraulic brake system, with the aid of which the loss in braking effect of the regenerative brake may be compensated for, at least in a low speed range. In this case, the entire braking torque may be applied via the hydraulic brake system, even when there is a full electrical energy store, when the regenerative brake usually does not exert any braking torque on the wheels.

On the other hand, in some situations it is desirable to exert the lowest possible hydraulic braking force on the wheels in order to achieve a high rate of regeneration. For example, after switching operations the decoupled generator is often activated as a regenerative brake to ensure reliable charging of the temporary buffer store and a high level of energy savings.

In general, a driver prefers an overall braking torque of his vehicle which corresponds to his operation of a brake activation element, such as his operation of a brake pedal, for example, independently of activation or deactivation of the regenerative brake. Some electric vehicles and hybrid vehicles therefore have an automatic system which is designed to adapt the braking torque of the hydraulic brake system to the instantaneous braking torque of the regenerative brake in such a way that a desired overall braking torque is maintained. Thus, the driver himself does not have to take over the task of the deceleration controller by adapting the braking torque of the hydraulic brake system to the instantaneous braking torque of the regenerative brake by appropriately operating the brake activation element. Examples of such an automatic system include brake by wire brake systems, in particular EHB systems. However, brake by wire brake systems are relatively expensive due to their complicated electronic systems, mechanical, and hydraulic systems.

Published German patent application document DE 10 2009 026 960 A1 describes a method for controlling a braking operation of a hybrid vehicle. The brake system used for this purpose preferably has a free travel distance between a brake pedal and a piston of the master brake cylinder. Within the free travel distance, a force which counteracts the braking operation by the driver is exerted on the brake pedal with the aid of a brake booster. In this way, the intent is to ensure that the decoupling of the brake pedal is not noticeable to the driver during the braking operation, and at the same time, that the generator of the hybrid vehicle is usable for charging the vehicle battery. If the braking effect of the generator is not sufficient for a braking effect corresponding to the operation of the brake pedal by the driver, an attempt is to be made to build up hydraulic brake pressure in the wheel brake cylinders by closing the at least one isolation valve and/or activating the at least one hydropump of the brake system.

### BRIEF SUMMARY OF THE INVENTION

The present invention allows the use of an inexpensive spring device for providing a “free travel distance,” the spring device at the same time being usable as a force simulator (pedal simulator, pedal travel simulator). Due to the “free travel distance” which is provided, operation of the brake activation element, a brake pedal, for example, for an actuator travel distance which is less than the minimum actuator travel distance does not result in the driver directly braking the piston-cylinder unit for increasing the internal pressure present therein. Thus, when the brake activation element is operated in this way, the vehicle may be decelerated with the aid of an electric and/or magnetic (nonhydraulic) braking device, in particular a regenerative braking device such as a generator, for example, without this resulting in an undesired exceedance of the intended braking input by the driver. Thus, the use of a generator for charging the vehicle battery does not cause excessive deceleration of the vehicle, and therefore is not noticeable to the driver. At the same time, feedback may be provided with the aid of the spring device, so that the driver perceives a customary braking feel. The present invention thus ensures an inexpensive option for achieving a braking feel (pedal feel) which is comfortable for the driver. However, the regenerative braking device is just one possible example of an electric and/or magnetic braking device via which the present invention may be applied. For example, the electric and/or magnetic braking device may also include a parking brake.

Another advantage of the present invention is that the “free travel distance” achieved by the spring device is easily covered by the driver operating the brake activation element for at least the minimum actuator travel distance. Thus, with a reasonable effort the driver is able to directly brake the piston-cylinder unit, for example a master brake cylinder.

One significant advantage of the spring device over a brake booster is that the spring device does not require the provision of energy. In addition, the installation space requirements of the spring device are comparatively small.

Furthermore, in the present invention the first brake booster is usable for building up a hydraulic braking torque as a supplement or an alternative to a generator braking torque when transmission of braking force by the driver is prevented. Thus, for example, an excessively low generator braking torque may be compensated for by building up the hydraulic braking torque with the aid of the first brake booster, so that a desired overall braking torque, preferably corresponding to operation of the brake activation element by the driver, is maintained. In addition, in situations in which it is advantageous to not use the generator, instead of the generator braking torque the hydraulic braking torque may be built up with the aid of the first brake booster. In the present invention, for building up the hydraulic braking torque it is not necessary in these situations to close isolation valves and/or to activate pumps of the hydraulic braking circuit. This has the advantage that the hydraulic braking torque may be built up comparatively quickly and easily. Since building up the hydraulic braking torque also does not require uncustomary use of a component of the hydraulic brake system, the brake system described here may thus be equipped with a plurality of brake circuits or various types of hydraulic brake circuit components. The brake system described here thus simplifies alternation of its hydraulic components.

### BRIEF DESCRIPTION OF THE DRAWINGS

FIGS. 1A through 1D show schematic illustrations of a first example embodiment of the brake system in various operating modes.

FIGS. 2A through 2D show schematic illustrations of a second example embodiment of the brake system in various operating modes.

FIG. 3 shows a flow chart for illustrating one example embodiment of the method for operating a brake system for a vehicle.

### DETAILED DESCRIPTION OF THE INVENTION

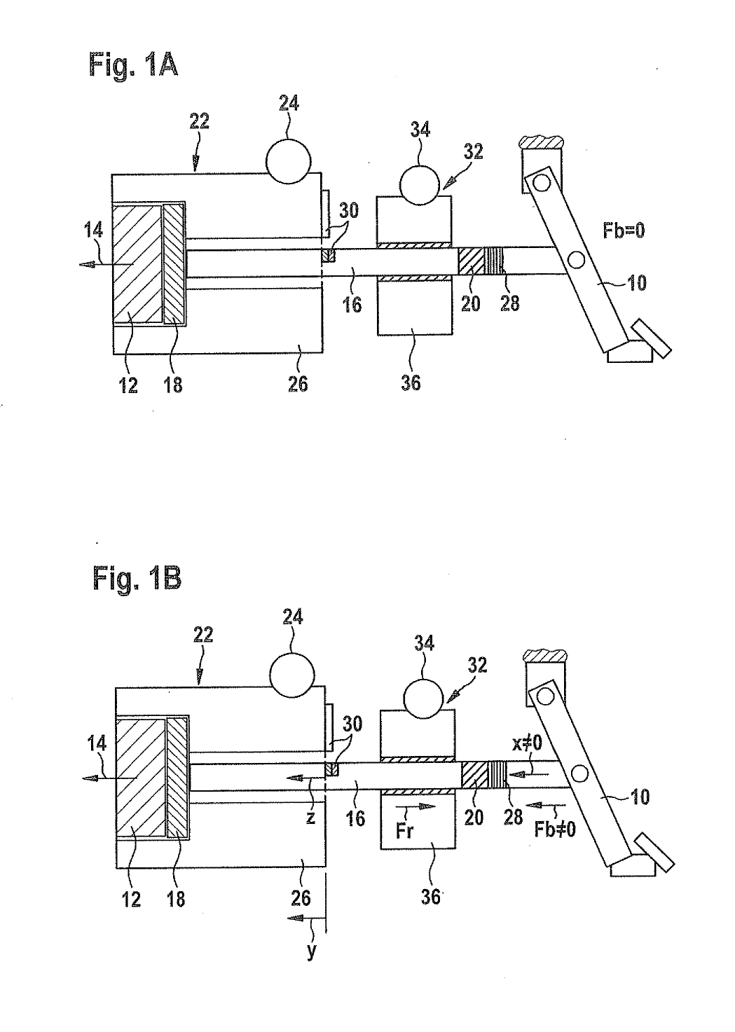

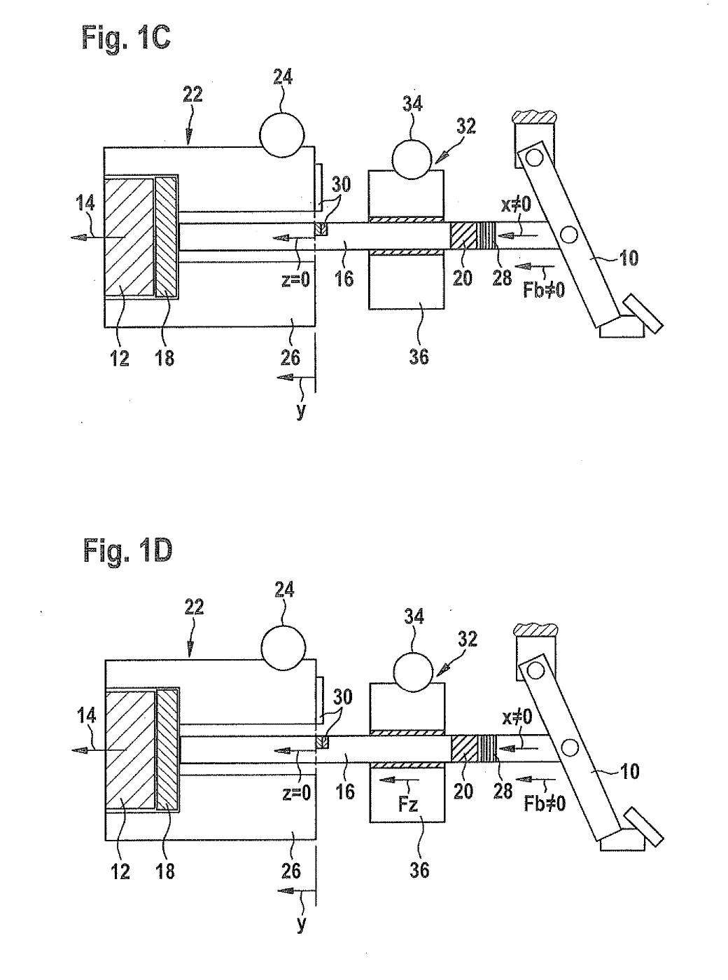

FIGS. 1A through 1D show schematic illustrations of a first example embodiment of the brake system in various operating modes.

The brake system, illustrated only partially in FIGS. 1A through 1D, has a brake activation element 10 which is designed as a brake pedal. However, the brake system described here is not limited to a design of brake activation element 10 as a brake pedal. As an alternative or in addition to a brake pedal, the brake system may have, for example, a brake activation element 10 which is designed for manual operation.

For decelerating a vehicle equipped in this way, the brake system includes a hydraulic braking device (not illustrated) having at least one piston-cylinder unit. An output piston 12 is situated on the piston-cylinder unit in such a way that an internal pressure in the piston-cylinder unit is increasable by displacing output piston 12 in displacement direction 14. For example, for this purpose output piston 12 may be displaceable at least partially into the piston-cylinder unit, along displacement direction 14. The piston-cylinder unit is preferably a master brake cylinder, such as a tandem master brake cylinder, for example. However, the brake system schematically illustrated here is not limited to a direct arrangement of output piston 12 on or at least partially in the piston-cylinder unit.

The hydraulic braking device (not illustrated) of the brake system may include at least one brake circuit having at least one wheel brake cylinder which is hydraulically connected to the piston-cylinder unit in such a way that at least one hydraulic braking torque is exertable on the wheel of the vehicle associated with the wheel brake cylinder with the aid of the increased internal pressure in the piston-cylinder unit. However, the brake system described here is not limited to a specific design of the at least one brake circuit and/or a specific type of the wheel brake cylinder used. In particular, there is unlimited freedom of choice for providing the at least one brake circuit with hydraulic components. For this reason, the at least one brake circuit, which in particular may be designed for a II- or X-brake circuit division, is not discussed further.

The brake system also has an input piston 16 which is displaceable from its starting position with the aid of brake activation element 10 which is displaced by at least one predefined minimum actuator travel distance. The starting position of input piston 16 may be understood to mean the position of input piston 16 when brake activation element 10 is not operated, i.e., when a driver braking force Fb is zero. Driver braking force Fb is transmittable to output piston 12 via displaced input piston 16 in such a way that output piston 12 is displaced, and the internal pressure in the piston-cylinder unit is increasable with the aid of displaced output piston 12. A transmission of driver braking force Fb from input piston 16 to output piston 12 is achievable, for example, via a reaction disk 18 situated in between. For example, input piston 16 may contact reaction disk 18 at its side facing brake activation element 10, while output piston 12 is situated at the side of reaction disk 18 facing away from brake activation element 10. However, it is pointed out that reaction disk 18 represents only one example of an elastic force transmission element which may be used between output piston 12 and input piston 16. Likewise, the brake system described here is not limited to provision of such an elastic force transmission element.

The brake system also has a spring device 20 via which input piston 16 is situated at brake activation element 10 or is connected to the brake activation element. Spring device 20 is situated between brake activation element 10 and input piston 16 in such a way that, when brake activation element 10 is operated for an actuator travel distance which is not equal to zero and which is less than the minimum actuator travel distance, spring device 20 is deformable in such a way that transmission of the driver braking force from brake activation element 10, which is displaced by the actuator travel distance, to output piston 12 is prevented. This is achievable, for example, by designing spring device 20 in such a way that transmission of the driver braking force from brake activation element 10, which is displaced by the actuator travel distance, to output piston 12 is prevented due to input piston 16 being in its starting position. In other words, when brake activation element 10 is displaced by an actuator travel distance which is not equal to zero but which is less than the minimum actuator travel distance, spring device 20 may be pushed together/compressed in such a way that input piston 16 remains in its starting position, and therefore output piston 12 is not carried along in displacement direction 14 by displaced input piston 16.

Spring device 20 thus ensures a “free travel distance” within which transmission of driver braking force Fb to output piston 16, and thus, direct braking of the piston-cylinder unit by the driver for increasing the internal pressure, is prevented. In other words, brake activation element 10 is displaceable by the “free travel distance” without driver braking force Fb being transmitted to output piston 16, thus preventing/suppressing the internal pressure in the piston-cylinder unit from increasing during the displacement of brake activation element 10 by the “free travel distance.” This “free travel distance” may be overcome with comparatively little effort by the driver, so that the driver has the option of directly braking the piston-cylinder unit with a reasonable effort. Thus, even when the electrical components of the brake system are malfunctioning, for example due to an interruption in the power supply, the driver is still able to initiate/bring about a hydraulic braking torque for decelerating his vehicle by directly braking the piston-cylinder unit.

In addition, deformable spring device 20 is designed in such a way that deformation/compression of spring device 20 results in feedback, detectable by the driver, of his operation of brake activation element 10. Thus, the driver has an operation feel/braking feel (pedal feel), even when brake activation element 10 is displaced by an actuator travel distance which is not equal to zero but which is less than the minimum actuator travel distance, despite output piston 12 not being carried along in relation to the piston-cylinder unit. This pedal feedback/restoring force exerted by spring device 20 on operated brake activation element 10 ensures improved operating comfort of brake activation element 10 for the driver. In particular, spring device 20 may have a force-displacement spring constant (characteristic curve) which corresponds to the operation feel/braking feel (pedal feel) to which the driver is accustomed. In one advantageous specific embodiment, spring device 20 has a force-displacement spring constant (characteristic curve) which corresponds to a force-displacement constant of a brake pedal. Further advantages of spring device 20 are discussed in greater detail below.

The brake system also has at least one first brake booster 22, with the aid of which, at least when brake activation element 10 is operated for the actuator travel distance which is not equal to zero and which is less than the minimum actuator travel distance, output piston 12 is displaceable in such a way that the internal pressure in the piston-cylinder unit is increasable. Thus, in a situation in which output piston 12 is not displaced via transmission of driver braking force Fb via input piston 16, there is the option of increasing the internal pressure in the piston-cylinder unit with the aid of first brake booster 22. Advantageous applications for increasing the internal pressure in the piston-cylinder unit and for building up at least one hydraulic braking torque with the aid of first brake booster 22 are discussed further below.

It is pointed out that the internal pressure in the piston-cylinder unit may be increased in a comparatively simple manner with the aid of first brake booster 22. In particular, carrying out such an increase is generally quicker than building up a hydraulic braking torque of a wheel brake cylinder by operating at least one pump of a hydraulic brake circuit.

The first brake booster may, for example, have a motor 24, with the aid of which an assisting piston 26 is displaceable independently of input piston 16. Assisting piston 26 may, for example, contact the side of reaction disk 18 facing brake activation element 10. In particular, input piston 16 may extend, at least partially, through a cavity in assisting piston 26.

It is pointed out that the force transmission contact between first brake booster 22 and output piston 12 does not have to occur via assisting piston 26 and/or reaction disk 18. The above-described provision of the brake system with reaction disk 18 and assisting piston 26 is understood to be merely an example. Furthermore, the brake system is not limited to a specific design of components 12, 16, and/or 26. The usable forms of components 12, 16, and 26 are practically unlimited.

First brake booster 22 may be an electromechanical brake booster and/or a hydraulic brake booster. In particular, the first brake booster may be designed as a continuously regulatable/controllable brake booster. However, first brake booster 22 is not limited to a specific type of brake booster. First brake booster 22 may preferably be controlled by taking into account an ascertained variable concerning the operation of brake activation element 10 by the driver, for example an ascertained braking force and/or a determined braking distance. For example, for activating first brake booster 22, a signal, provided by a force sensor 28, concerning driver braking force Fb exerted on brake activation element 10 may be evaluated. Alternatively or additionally, the first brake booster may be activated by taking into account a distance differential by which input piston 16 is displaced in relation to assisting piston 26. Such a distance differential may be ascertained with the aid of a path sensor 30. For example, path sensor 30 may be a magnetic sensor, in particular a Hall sensor. However, numerous other types of sensors may also be used as sensors 28 and 30. Likewise, the described brake system is not limited to a design having sensors 28 and 30.

Optionally, the brake system may be equipped with a second brake booster 32. However, providing the brake system with second brake booster 32 may also be dispensed with, in particular when spring device 20 has a force-displacement spring characteristic which corresponds to a preferred (standard) characteristic curve of brake activation element 10. In this case, it is not necessary to use the second brake booster for improving the operation feel/braking feel (pedal feel) for the driver.

Second brake booster 32 may also be an electromechanical brake booster and/or a hydraulic brake booster. Likewise, second brake booster 32 may also be designed as a continuously regulatable/controllable brake booster. Second brake booster 32 may have a motor 34, which is connected to input rod 16 via a force transmission element/coupling element 36. Models having the identical basic design may be used for the two brake boosters 22 and 32. This reduces the manufacturing costs for the brake system.

Force transmission element 36 may be designed in such a way that second brake booster 32 is fixedly connected to input rod 16. An important advantage of providing the brake system with the two brake boosters 22 and 32 results from the use of two essentially identical subsystems, and the multiple utilization of components as a function of operating states of the brake system or the vehicle which is thus ensured. In particular, with the aid of second brake booster 32, the braking feel for an actuator travel distance which is not equal to zero but which is less than the minimum actuator travel distance, i.e., for a small driver braking force Fb, may have a very variable design. One particularly advantageous application of second brake booster 32 is discussed in greater detail below.

The brake system advantageously has at least one electric and/or magnetic braking device with the aid of which a (nonhydraulic) braking device braking torque is exertable on at least one wheel. In one particularly advantageous specific embodiment, the brake system is designed as a regenerable brake system having a generator (not illustrated). However, the usability of the brake system is not limited to cooperation with a generator, as described below:

FIG. 1A shows the brake system when brake activation element 10 is not in operation (Fb=0). In this situation, brake activation element 10 and pistons 12, 16, and 26 are in their starting positions. Stated in another way, in such a starting situation brake activation element 10 and/or pistons 12, 16, and 26 are in their neutral positions.

FIG. 1B shows the brake system when brake activation element 10 is displaced slightly from its starting position (Fb≠0). Brake activation element 10 is displaced from its starting position (for x=0) by an actuator travel distance x which is not equal to 0 (x≠0) and which is less than the minimum actuator travel distance. Actuator travel distance x of brake activation element 10 is a displacement path by which brake activation element 10 is displaced from its starting position for a driver braking force Fb which is not equal to zero. In particular, an actuator travel distance may be understood to mean a rotary path of a lever-shaped component of brake activation element 10 about a rotational axis, and/or a translatory path of a translationally displaceable component of brake activation element 10.

For an actuator travel distance x which is less than the minimum actuator travel distance, i.e., for such a small driver braking force Fb, transmission of the driver braking force to the output piston is prevented/suppressed via deformation/compression of spring device 20 caused by driver braking force Fb. This may be achieved, for example, by designing spring device 20 in such a way that the force that is sufficient for deforming/compressing spring device 20 for an actuator travel distance x which is less than the minimum actuator travel distance is smaller than a force for displacing input piston 16. The minimum actuator travel distance may thus also be understood as an actuator travel distance x, in which spring device 20 is deformed/compressed in such a way that a force for additionally deforming/compressing spring device 20 is greater than a frictional force which counteracts the displacement of input piston 16.

Via the advantageous design of spring device 20, the fixed relationship, generally present in conventional brake systems, between the actuator travel distance of brake activation element 10, a hydraulic volume which is displaced in the piston-cylinder unit, and a hydraulic braking torque which is thus built up, is replaced by a variable relationship. The replacement of the fixed relationship by the variable relationship may also be described in such a way that a separation of the mechanical connection between brake activation element 10 and the piston-cylinder unit is achievable due to the advantageous design of the spring device. For this reason, the brake system described here may be used particularly well for regeneration.

In particular when brake activation element 10 is operated for an actuator travel distance x which is less than the minimum actuator travel distance, the brake system may be used particularly well for charging a vehicle battery. Since the fixed connection between brake activation element 10 and the piston-cylinder unit, which is generally present in conventional brake systems, is eliminated, a generator of the brake system may be used for decelerating the vehicle without the intended braking input by the driver being exceeded. During the regeneration, in particular a setpoint variable of an overall braking torque to be exerted on the vehicle which corresponds to the operation of brake activation element 10 by the driver may be ascertained/determined with the aid of force sensor 28 and/or a braking distance sensor for ascertaining actuator travel distance x. In this case, the generator braking torque exerted by the generator may be set in such a way that the overall braking torque, which corresponds to the ascertained/determined setpoint variable, is not exceeded.

If the generator braking torque which is exertable by the generator is less than the overall braking torque which corresponds to the ascertained/determined setpoint variable, a hydraulic braking torque corresponding to a deviation of the generator braking torque from the overall braking torque, which corresponds to the ascertained/determined setpoint variable, may be additionally built up with the aid of first brake booster 24. Likewise, if use of the generator is not desired/possible, for example because the vehicle battery is already fully charged, a hydraulic braking torque corresponding to the setpoint variable may be built up with the aid of first brake booster 24. Thus, the driver does not notice activation/deactivation of the generator. In both cases, assisting piston 26 is displaced from its starting position by a displacement path y. In addition, distance differential z between input piston 16 and assisting piston 26 is not equal to zero.

During the regeneration illustrated with reference to FIG. 1B, second brake booster 32 may be used to improve the operation feel/braking feel for the driver. For this purpose, a restoring force Fr which is not equal to zero is exerted on brake activation element 10 with the aid of second brake booster 32. Restoring force Fr which is provided may be built up in such a way that there is a standard response of brake activation element 10 to operation by the driver. Thus, the operation of the generator for charging the vehicle battery is not perceivable by the driver, either because the braking force predefined by the driver is not maintained or because of a different response of brake activation element 10.

Since restoring force Fr which is provided by second brake booster 32, together with the elastic force of spring device 20, acts additively on brake activation element 10, an advantageous braking feel/operation feel is ensured, even with a comparatively small maximum providable restoring force Fr. Thus, a model which is inexpensive and/or which requires little installation space may be used for second brake booster 32.

The brake system may be designed, for example, in such a way that a separation of the mechanical connection between brake activation element 10 and the piston-cylinder unit is present up to a setpoint variable/overall braking torque which is equal to the maximum applicable generator braking torque. In particular, input piston 16 may be displaced from its starting position only after a minimum braking distance which is equal to an overall braking torque corresponding to a vehicle deceleration of 0.3 g. This is easily achievable via an appropriate design of spring device 20.

If second brake booster 32 is present, during the regeneration mode illustrated with reference to FIG. 1B the second brake booster may also be used, in addition to its simulator function, as a brake booster for increasing the internal pressure in the piston-cylinder unit in other operating modes. This is described with reference to further FIGS. 1C and 1D:

FIG. 1C shows the brake system after brake activation element 10 has been displaced by at least the minimum actuator travel distance. After brake activation element 10 has been displaced by at least the minimum actuator travel distance, the brake system is controlled in a direct braking mode in which spring device 20 (and second brake booster 32, if present) allow(s) input piston 16 to be carried along with brake activation element 10. The rod travel distance (not illustrated) by which input piston 16 is carried along, from its starting position, with brake activation element 10 is preferably a function of driver braking force Fb. In this case, first brake booster 22 is able to operate in a conventional manner, i.e., to provide an assisting force in which distance differential z is zero. In other words, the assisting force provided by first brake booster 22 is a function of driver braking force Fb.

FIG. 1D shows the brake system when brake activation element 10 is operated for specifying a high rate of vehicle deceleration, for example a setpoint vehicle deceleration of at least 0.6 g, in particular at least 0.8 g. For a relatively high setpoint vehicle deceleration, i.e., when the brake activation element is operated for at least a limiting actuator travel distance which is greater than the minimum actuator travel distance, the brake system is preferably controllable in an enhanced braking mode in which second brake booster 32 is also usable for conventionally increasing the brake pressure. In this case, in the enhanced braking mode second brake booster 32 is able to exert an additional force Fz on input piston 16, which is directed away from brake activation element 10. Additional force Fz may in particular be a function of driver braking force Fb, so that the rod travel distance of the input piston is a function of driver braking force Fb. Similarly, the assisting force from first brake booster 22 (not illustrated) may also be a function of driver braking force Fb, so that distance differential z remains zero.

The method steps described above may be carried out by equipping the brake system with a control device which provides control signals for exerting a force, corresponding to the instantaneous operating mode, on first brake booster 22 (and optionally also on second brake booster 32). The design of such a control device is apparent based on the description of the individual operating modes, and therefore is not discussed further here.

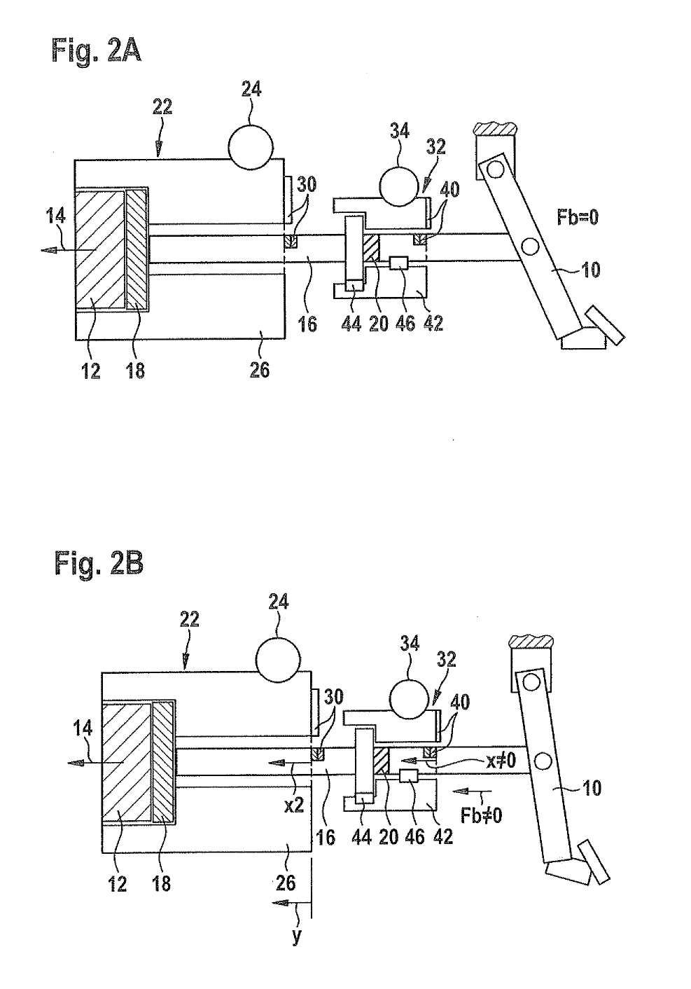

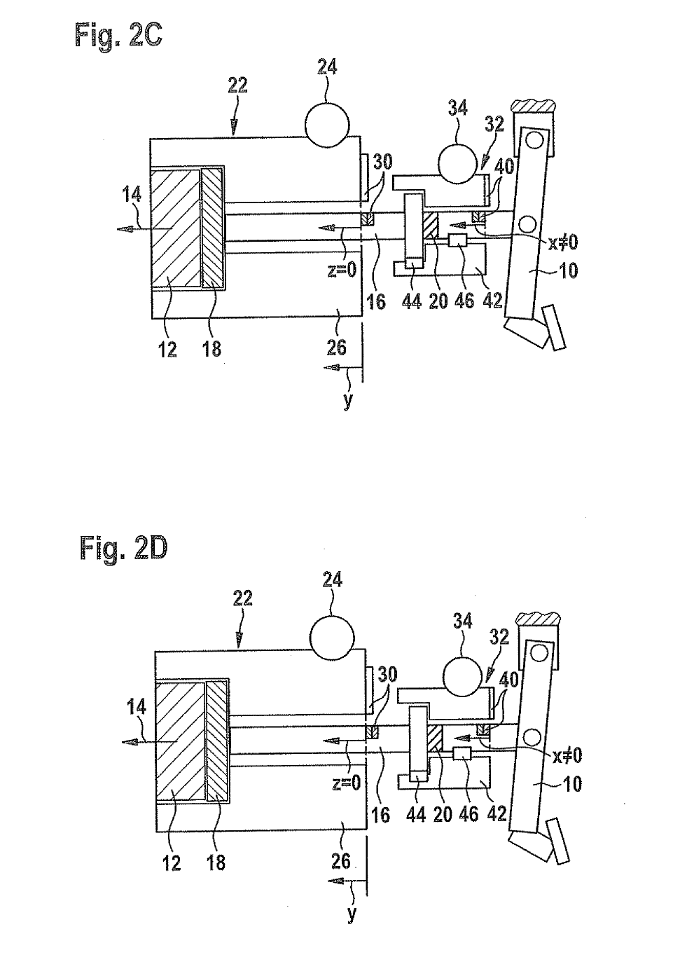

FIGS. 2A through 2D show schematic illustrations of a second example embodiment of the brake system in various operating modes.

The brake system, schematically illustrated in part in FIGS. 2A through 2D, includes components 10, 12, 16 through 26, and 30 through 34, which have already been described. These components are not described again here.

The brake system has a braking distance sensor 40 for ascertaining a variable concerning actuator travel distance x of brake activation element 10. Braking distance sensor 40 may, for example, be a magnetic sensor, in particular a Hall sensor. However, the brake system described below is not limited to provision of such a braking distance sensor 40.

In addition, the brake system has no fixed connection of second brake booster 32 to input piston 16. Instead, second brake booster 32 is connectable to input piston 16 and/or to brake activation element 10 via a connecting element 42 for a fixable free travel distance. Connecting element 42 includes a first coupling element 44 and a second coupling element 46. Activating first coupling element 44 establishes a fixed coupling between input rod 16 and second brake booster 32, i.e., a fixed connection of second brake booster 32 to input rod 16. Second coupling element 46 fixedly couples second brake booster 32 to brake activation element 10 or to a translationally displaceable component which is connected to brake activation element 10. Thus, the operative connection between the two brake boosters 22 and 32 is controllable. The two coupling elements 44 and 46 may be two electrically switchable couplings, for example.

FIG. 2A shows the brake system when brake activation element 10 is not in operation (Fb=0). Stated in another way, in such a starting situation, brake activation element 10 and pistons 12, 16, and 26 are in their neutral positions. Driver braking distance x, distance differential z, and rod travel distance y of assisting piston 26 are zero.

FIG. 2B shows the brake system when brake activation element 10 is displaced by an actuator travel distance x which is not equal to zero, but which is less than the minimum actuator travel distance, with the aid of a driver braking force Fb. In this operating mode, braking distance x may be ascertained with the aid of braking distance sensor 40 and evaluated for establishing a setpoint variable concerning the overall braking torque to be exerted on the vehicle. As described above, a hydraulic braking torque corresponding to a difference between the overall braking torque, which corresponds to the established setpoint variable, and the generator braking torque which is instantaneously exerted by a generator may be subsequently built up with the aid of first brake booster 22. Thus, also in this specific embodiment of the brake system, the vehicle battery is chargeable while maintaining the braking force predefined by the driver or the correspondingly established setpoint variable.

Second brake booster 32 may be used to improve the operation feel/braking feel of brake activation element 10. When second coupling element 46 is not activated, first coupling element 44 of connecting element 42 may be activated beforehand so that a fixed coupling is present between input rod 16 and second brake booster 32, but there is no fixed connection of second brake booster 32 to brake activation element 10. In this case, transmission of driver braking force Fb to the output piston may be prevented/suppressed with the aid of spring device 20 and second brake booster 32. In particular, during operation of brake activation element 10 for an actuator travel distance which is not equal to zero but which is less than the minimum actuator travel distance, input piston 16 may be kept in its starting position by closing first coupling element 44. At the same time, feedback of the operation of brake activation element 10 may be provided to the driver, at least via the deformation of spring device 20. The feedback is adaptable to a preferred (standard) activation characteristic of brake activation element 10 via a suitable design of spring device 20 and/or exertion of a restoring force on brake activation element 10 with the aid of second brake booster 32.

FIG. 2C shows the brake system after brake activation element 10 has been displaced by an actuator travel distance of at least the minimum actuator travel distance, which corresponds to a setpoint vehicle deceleration of 0.3 g, for example. This direct braking mode, which is regulated when the minimum actuator travel distance is exceeded, is preferably started by activating second coupling element 46 in addition to first coupling element 44. Thus, after the two coupling elements 44 and 46 are jointly activated, a fixed connection is present between input piston 16 and brake activation element 10. After the two coupling elements 44 and 46 are activated, input piston 16 may thus be carried along with brake activation element 10, and therefore output piston 12 may also be carried along with brake activation element 10. This results in direct braking by the driver after the two coupling elements 44 and 46 are activated. Due to the reduced requirement for the force which it is able to provide, second brake booster 32 may have an inertial torque which is so small that second brake booster 32 is carried along with brake activation element 10 and input rod 16.

In the direct braking mode, first brake booster 22 is preferably operated in a conventional manner, so that the assisting force provided by first brake booster 22 is a function of driver braking force Fb. Stated in another way, distance differential z is regulated to zero with the aid of first brake booster 22. At the same time, the driver braking distance is regulatable in such a way that it corresponds to a braking distance characteristic which is standard for the driver.

FIG. 2D shows the brake system for an actuator travel distance x of at least the limiting actuator travel distance for specifying a comparatively high setpoint vehicle deceleration. This is the case in particular, for example, for a setpoint vehicle deceleration of at least 0.6 g, in particular for a setpoint vehicle deceleration of at least 0.8 g, set by the driver. In this case the brake system is switchable to the enhanced braking mode by deactivating the two coupling elements 44 and 46 and activating the two brake boosters 22 and 32 for conventional operation. First brake booster 22 is preferably activated in such a way that distance differential z is zero. Second brake booster 32 is advantageously operated in the enhanced braking mode in such a way that braking distance x corresponds to a braking distance characteristic which is standard for the driver. Stated in another way, for a particularly high setpoint vehicle deceleration the function of the first brake booster is assistable with the aid of second brake booster 32.

The specific embodiments described above ensure the advantage that second brake booster 32 is usable as a pedal simulator for regeneration up to the maximum regenerative deceleration. In addition, the two brake boosters 22 and 32 may be used additively for building up a high hydraulic braking torque on at least one wheel. This allows in particular a comparatively small and cost-effective design of second brake booster 32.

Depending on the operating state of the brake system, the two brake boosters 22 and 32, which are controllable independently of one another, may also be oppositely activated with respect to one another. The brake system having the two brake boosters 22 and 32 thus has a high level of dynamics.

Another advantage of these specific embodiments is the increased residual functionality in the event of failure of one of the two brake boosters 22 and 32, compared to a conventional brake system having only one brake booster. At the same time, all of the described specific embodiments ensure that in the event of failure of the two brake boosters 22 and 32, for example due to an impairment of the power supply to the electronics system, there is a mechanical-hydraulic intervention by brake activation element 10 on the wheel brake cylinders.

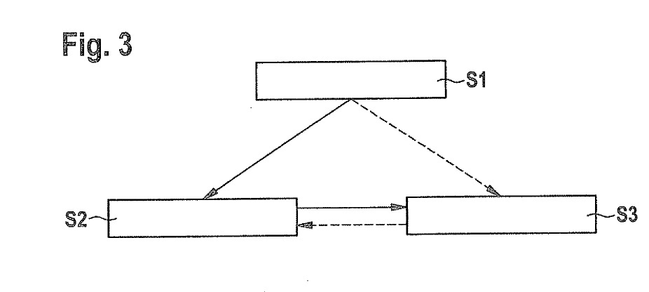

FIG. 3 shows a flow chart for illustrating one example embodiment of the method for operating a brake system for a vehicle.

The method may be carried out using a brake system having a brake activation element; an input piston which is displaced by at least a predefined minimum actuator travel distance when the brake activation element is operated, in such a way that a driver braking force is transmitted from the brake activation element to an output piston via the displaced input piston, thus increasing an internal pressure in a piston-cylinder unit of the brake system; and a spring device which is deformed by an actuator travel distance which is not equal to zero and which is less than the minimum actuator travel distance when the brake activation element is operated, in such a way that transmission of the driver braking force to the output piston is prevented. In addition, the suitable brake system includes a first brake booster and at least one electric and/or magnetic braking device, such as a generator and/or a parking brake, for example.

In a method step S1, the operation of the brake activation element for the actuator travel distance which is not equal to zero and which is less than the minimum actuator travel distance is recognized. A force sensor and/or a path sensor, for example, may be used to recognize the operation of the brake activation element. A setpoint variable concerning an overall braking torque to be exerted on the vehicle is then established, taking the operation of the brake activation element into account.

In a subsequent method step S2, the at least one electric and/or magnetic braking device is controlled in a mode in which a braking device braking torque of the electric and/or magnetic braking device is less than or equal to the overall braking torque, corresponding to the established setpoint variable, which is exerted on at least one wheel of the vehicle. A generator as at least one electric and/or magnetic braking device is preferably controlled in such a way that a generator braking torque is exerted on the at least one wheel of the vehicle as at least part of the braking device braking torque. The method described here is thus usable in particular for advantageously charging a vehicle battery.

In a method step S3, which may be carried out before, concurrently with, or after method step S2, the first brake booster is controlled taking into account a difference between the overall braking torque, corresponding to the established setpoint variable, and the braking device braking torque of the electric and/or magnetic braking device, in such a way that the output piston is displaced with the aid of the first brake booster, thus resetting the internal pressure in the piston-cylinder unit. This ensures the advantages described above.

For example, for a decreasing generator braking torque the internal pressure in the piston-cylinder unit may be increased in method step S3. The overall braking torque exerted on the vehicle may thus be held at a value predefined by the driver, even after the battery is fully charged or after the vehicle is decelerated to a speed below the predefined minimum speed for starting the generator. Similarly, when the intended braking input is reduced by the driver and/or when the generator braking torque is increased, the internal pressure may be reduced in method step S3 in order to maintain the overall braking torque. Thus, resetting the internal pressure may be understood to mean an adjustment to the intended braking input and to the generator braking torque which is instantaneously present, i.e., a corresponding braking device braking torque of the electric and/or magnetic braking device.

Optionally, when the operation of the brake activation element for the actuator travel distance which is not equal to zero and which is less than the minimum actuator travel distance is recognized, in addition a restoring force may be exerted on the brake activation element with the aid of a second brake booster. The second brake booster may also be advantageously used to exert an additional force on the input piston which is directed toward the output piston, also when the operation of the brake activation element for at least a predefined limiting actuator travel distance which is greater than the minimum actuator travel distance is recognized. A particularly advantageous functionality of the second brake booster is ensured in particular when the input piston is coupled to the second brake booster when the operation of the brake activation element for the actuator travel distance which is not equal to zero and which is less than the minimum actuator travel distance is recognized. In addition, the brake activation element may also be coupled to the second brake booster when operation of the brake activation element for the minimum actuator travel distance is recognized. The driver then has the option of directly braking the piston-cylinder unit. It is also advantageous when the input piston and brake activation element 10 are decoupled from the second brake booster when the operation of the brake activation element for at least the predefined limiting actuator travel distance is recognized. During a heavy braking operation, the energy applied to deform/compress the spring device is thus usable for building up a high internal pressure in the piston-cylinder unit.

The method steps described above may also be carried out by the above-mentioned control device of the brake system. Therefore, a more detailed description of the control device is dispensed with here.

What is claimed is:

1. A brake system for a vehicle, comprising:
a brake activation element;
an input piston which is displaced from a starting position by at least a predefined minimum actuator travel distance when the brake activation element is operated;
an output piston to which a driver braking force is transmitted from the brake activation element via the displaced input piston in such a way that the output piston is displaced to cause an internal pressure in a piston-cylinder unit of the brake system to increase;
a first brake booster; and
a spring device via which the input piston is situated at the brake activation element in such a way that, when the brake activation element is operated for an actuator travel distance which is not equal to zero and which is less than the minimum actuator travel distance, the spring device is deformed in such a way that transmission of the driver braking force from the brake activation element, which is displaced by the actuator travel distance, to the output piston is prevented;
wherein the output piston is displaced with the aid of the first brake booster, when the brake activation element is operated for the actuator travel distance which is not equal to zero and which is less than the minimum actuator travel distance, in such a way that the internal pressure in the piston-cylinder unit is increased.

2. The brake system as recited in claim 1, wherein, when the brake activation element is operated for the actuator travel distance which is not equal to zero and which is less than the minimum actuator travel distance, the spring device is compressed in such a way that the input piston remains in the starting position.

3. The brake system as recited in claim 2, wherein the spring device has a force-displacement spring constant which corresponds to a force-displacement constant of a brake pedal.

4. The brake system as recited in claim 2, further comprising:
at least one of an electric and magnetic braking device; and
a control device configured to:
(i) recognize the operation of the brake activation element for the actuator travel distance which is not equal to zero and which is less than the minimum actuator travel distance,
(ii) establish, taking into account the operation of the brake activation element, a setpoint variable for an overall braking torque to be exerted on the vehicle,
(iii) control the at least one of the electric and magnetic braking device in a mode in which a braking device braking torque of the at least one of the electric and magnetic braking device which is less than or equal to the overall braking torque corresponding to the established setpoint variable is exerted on at least one wheel of the vehicle, and
(iv) activate the first brake booster, taking into account a difference between the overall braking torque corresponding to the established setpoint variable and the braking device braking torque of the at least one of the electric and magnetic braking device, in such a way that the output piston is displaced with the aid of the first brake booster to reset the internal pressure in the piston-cylinder unit.

5. The brake system as recited in claim 4, wherein the at least one of the electric and magnetic braking device includes a generator configured to produce a generator braking torque as at least part of the braking device braking torque, wherein the generator braking torque is exerted on the at least one wheel of the vehicle.

6. The brake system as recited in claim 4, further comprising:
a second brake booster configured to provide at least one of: (i) a restoring force exerted on the brake activation element, at least when the brake activation element is operated for the actuator travel distance which is not equal to zero and which is less than the minimum actuator travel distance; and (ii) an additional force directed toward the output piston and exerted on the input piston, at least when, the brake activation element is operated for at least a predefined limiting actuator travel distance which is greater than the minimum actuator travel distance.

7. The brake system as recited in claim 6, wherein the second brake booster is fixedly connected to the input piston via a force transmission element.

8. The brake system as recited in claim 6, wherein the second brake booster is connected to the input piston and to the brake activation element via a connecting element for a specified free travel distance.

9. The brake system as recited in claim 7, wherein the connecting element includes (i) a first coupling element via which the second brake booster is coupled to the input piston, and (ii) a second coupling element via which the second brake booster is coupled to the brake activation element.

10. The brake system as recited in claim 9, wherein the control device is additionally configured to:
(i) control the first coupling element into an active mode and control the second coupling element into an inactive mode, when the brake activation element is operated for the actuator travel distance which is not equal to zero and which is less than the minimum actuator travel distance,
(ii) control the first coupling element and the second coupling element into the active mode when the brake activation element is operated for the minimum actuator travel distance, and
(iii) control the first coupling element and the second coupling element into the inactive mode when the brake activation element is operated for at least the predefined limiting actuator travel distance.

11. A method for operating a brake system for a vehicle, the brake system having (i) a brake activation element, (ii) an input piston which is displaced from a starting position by at least a predefined minimum actuator travel distance when the brake activation element is operated, in such a way that a driver braking force is transmitted from the brake activation element via the displaced input piston to an output piston to cause the output piston to be displaced and increase an internal pressure in a piston-cylinder unit of the brake system, (iii) a spring device which is deformed when the brake activation element is operated for an actuator travel distance which is not equal to zero and which is less than the minimum actuator travel distance, in such a way that transmission of the driver braking force from the brake activation element, which is displaced by the actuator travel distance, to the output piston is prevented, (iv) a first brake booster, and (v) at least one of an electric and magnetic braking device, the method comprising:
recognizing the operation of the brake activation element for the actuator travel distance which is not equal to zero and which is less than the minimum actuator travel distance, and establishing a setpoint variable for an overall braking torque to be exerted on the vehicle, taking into account the operation of the brake activation element;
controlling the at least one of the electric and magnetic braking device into a mode in which a braking device braking torque of the at least one of the electric and magnetic braking device which is less than or equal to the overall braking torque corresponding to the established setpoint variable is exerted on at least one wheel of the vehicle; and
activating the first brake booster, taking into account a difference between the overall braking torque, which corresponds to the established setpoint variable, and the braking device braking torque of the at least one of the electric and magnetic braking device, in such a way that the output piston is displaced with the aid of the first brake booster to reset the internal pressure in the piston-cylinder unit.

12. The method as recited in claim 11, wherein the at least one of the electric and magnetic braking device is controlled in such a way to produce a generator braking torque as at least part of the braking device braking torque, wherein the generator braking torque is exerted on the at least one wheel of the vehicle.

13. The method as recited in claim 11, wherein at least one of (i) a restoring force is exerted on the brake activation element with the aid of a second brake booster when the brake activation element is operated for the actuator travel distance which is not equal to zero and which is less than the minimum actuator travel distance, and (ii) an additional force directed toward the output piston is exerted on the input piston with the aid of the second brake booster when the brake activation element is operated for at least a predefined limiting actuator travel distance which is greater than the minimum actuator travel distance.

14. The method as recited in claim 13, wherein the input piston is coupled to the second brake booster when the brake activation element is operated for the actuator travel distance which is not equal to zero and which is less than the minimum actuator travel distance, and the brake activation element is additionally coupled to the second brake booster when the brake activation element is operated for the minimum actuator travel distance.

15. The method as recited in claim 13, wherein the input piston and the brake activation element are decoupled from the second brake booster when the brake activation element is operated for at least the predefined limiting actuator travel distance.
